(19) United States
(12) Patent Application Publication
(10) Pub. No.: US 2010/0119682 A1
(43) Pub. Date: May 13, 2010

(54) PROTEIN EMULSION GELS AND PROCESSES FOR THEIR PREPARATION

(75) Inventor: Aiqian Ye, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 12/597,476

(22) PCT Filed: Apr. 24, 2008
(86) PCT No.: PCT/NZ08/00088

§ 371 Date: Jan. 26, 2010

(30) Foreign Application Priority Data
Apr. 24, 2007 (NZ) 554742

(51) Int. Cl. A23J 3/08; A23J 3/00; A23J 3/12; A23L 1/0562

(52) U.S. Cl. 426/576; 426/573

(57) ABSTRACT

The invention relates to a method for preparing a gel comprising mixing oil or fat with an aqueous medium by homogenisation to form an oil-in-water emulsion and heating the mixture to 50° C. to 200° C. for a period sufficient to form an emulsion gel wherein the mixture comprises 1.0% to 3.8% (w/w) of a protein that forms a heat-set gel, and 5 to 18% oil or fat or a mixture of oil and fat.

### TECHNICAL FIELD

The invention relates to protein emulsion gels and processes for their preparation. The gels may be used in or as foods.

### BACKGROUND ART

Food with a gel-like consistency may be obtained by including within an aqueous medium, a thickening agent. A variety of high molecular weight compounds have been used to form gels in foods. For example, starch, gums, pectins, and gelatines.

Egg proteins are frequently used for their thickening properties and also for their emulsifying properties. Eggs are expensive and require careful handling because of risks of contamination.

For thickening oil-in-water emulsions, one method involves use of whey proteins, which are commercially available in the dry state. U.S. Pat. No. 4,720,390 describes a process for producing a gelled food product where an oil-in-water emulsion is prepared from an aqueous medium and a lipidic medium. The emulsion contains 4-12% weight w/v of gellable whey proteins and 2.5-40% by volume of the lipidic medium. The process is characterised in that the aqueous medium is homogenised with a lipidic medium under such conditions that the emulsion formed contains a homogenous series of fat globules having a diameter of from 140-6000 nm and a mean diameter of less than 1000 nm. The emulsion is heat treated to form the gel.

Hunt & Dalgleish (J. Food Sci. 60, 1120-1131 (1995) prepared emulsions containing 20% soy bean oil made with 2% whey protein isolate (WPI) and a heat treatment. The resulting emulsions where described as stable.

It remains desirable to provide gels with relatively low protein concentrations to allow economic production but contain modest levels of fats or oils.

It is an object of the present invention to provide a protein gel with good nutritional properties or to at least offer the public a useful choice.

### DISCLOSURE OF THE INVENTION

1. In one aspect, the invention provides a method of preparing a gel comprising forming an oil-in-water emulsion by mixing oil or fat with an aqueous medium and homogenization, wherein the mixture comprises 1.0-3.8% (w/w) of a protein that forms a gel upon heating and 5-18% (w/w) oil or fat or a mixture of oil and fat. The emulsion is heated to 50-200° C. for a period sufficient to faun the emulsion gel. The invention therefore provides a method for preparing a gel comprising:
   (a) mixing oil or fat with an aqueous medium by homogenisation to form an oil-in-water emulsion; and
   (b) heating the mixture to 50° C. to 200° C. for a period sufficient to farm an emulsion gel
      wherein the mixture comprises 1.0% to 3.8% (w/w) of a protein that forms a heat-set gel, and 5 to 18% oil or fat or a mixture of oil and fat.

The protein can be from the group of proteins of animal or vegetable origin that form gels upon heating, preferably selected from the group consisting of soy proteins, whey proteins, myofibrillar (skeletal/meat) proteins, egg proteins, and blood proteins (Ziegler G. R. & Foegeding E. A. (1990). Advances in Food and Nutrition Research, vol 34, 203-298) most preferably whey proteins, soy proteins, meat proteins.

Preferably, the protein content of the emulsion is 1.4-3.7% (w/w), more preferably 1.8-3.6%, most preferably 2.0-3.5%. Especially preferred is a protein content of 2.0-3.0%.

Preferably the protein is whey protein or soy protein, especially whey protein. Most preferably, the whey proteins are provided from a whey protein isolate (WPI) or a whey protein concentrate (WPC).

A whey protein concentrate (WPC) is a whey fraction in which at least 35% (w/w) of the total solids comprises whey proteins. WPCs are generally prepared by ultrafiltration and/or diafiltration of whey. Preferably, the protein composition is substantially that of the whey from which it is derived. Preferred WPCs comprise at least 50% (w/w) of the total solids. WPCs may be in the form of liquid concentrates or dried powders.

A whey protein isolated (WPI) is a whey fraction in which at least 90% (w/w) of the total solids comprise whey proteins. WPIs are also generally prepared by a combination of microfiltration or ion exchange followed by ultrafiltration and/or diafiltration of whey. Again, the protein composition is preferably substantially that of the whey from which it was derived. WPIs WPCs may be in the form of liquid concentrates or dried powders.

Preferably, the oil or fat is present in an amount from 7-15%, more preferably 8-13% w/w. Preferably, the oil is vegetable oil, for example, soy bean oil, sunflower oil, olive oil, canola oil, or peanut oil, and the fat is milk fat. Those who are skilled in the art would understand that many other oils or fat can be used. Mixing may be carried out in any manner suitable for producing the oil-in-water emulsion. Normally this is carried out by homogenisation in a 1- or 2-stage homogeniser.

The length of the heat treatment is usefully varied depending on the temperature of the heat treatment. Shorter heat treatments may be used at the higher temperatures.

Preferred temperatures are in the range 70-200° C., more preferably 80-150° C. A 145° C. heating time of 5 seconds-30 minutes may be used whereas at 80° C. a heating time of 20 minutes-60 minutes is preferred. The presence of inorganic cations also influence the amount of heat treatment required.

The invention allows production of gels at whey protein concentrations lower than possible for whey protein gel in corresponding aqueous solutions with no emulsified fat or oil.

Gel formation can be enhanced by including within the emulsion or the mixture used to form the emulsion, inorganic ions. Especially preferred are soluble calcium ions and sodium ions. Addition of these ions allows use of lower concentrations of a protein and/or lower temperatures in the heat treatment steps. Preferably the inorganic ions are added as salts. Sodium chloride and calcium chloride are preferred salts for this purpose. For sodium chloride, addition of sufficient salt to provide a concentration of exogenous sodium chloride of 10-300 mM is preferred, more preferably 50-100 mM. Lower concentrations of calcium chloride may be used, with the preferred concentrations being in the range 4-12 mM. Those who are skilled in the art would understand that many inorganic ions could be added, including choosing an appropriately soluble salt.

The whey protein source that is currently preferred is a WPI if higher firmness is required.

The gelled products of the invention vary in firmness according to the pH. The pH may be in the range 4.0-7.5, preferably 4.0-7.0. If firm gels are preferred, a pH in the range 5.5-7.5 or 4.0-4.5 is preferred. At intermediate pHs, around pH 5, the gel firmness is lower. The less firm gels are of course useful in low pH products such as yoghurt. A pH around 5 should be avoided if possible, where a strong gel is required to add texture to a product.

Other ingredients may be included in the gel. One example is sugar, useful in preparing gel desserts. The components added may affect the gel strength. Increasing sugar concentration can increase gel firmness, possibly due to the increasing total solids in the emulsion. Those who are skilled in the art would understand that many useful additives could be incorporated to the water or the oil phases of the emulsion to improve the qualities of those emulsion gels, such as flavourings, colourants, and nutritional components.

The homogenisation pressure can be varied to vary the gel strength. Homogenisation pressure of 100-2000 bar is preferred for strong gels, preferably higher than 300 bar. The average droplet size of emulsions is preferably controlled at smaller than 1 μm or the droplet size distribution are between 0.05 to 10 μm.

The invention also contemplates drying of solutions before gelling to be used to later prepare gels or to include in foods as a gelling or thickening agent. Typically spray-drying is used for the drying, optionally after dewatering, for example by evaporation, such as falling film evaporation.

In a preferred embodiment of the invention the emulsion gel is cut into portions with dimensions in the range 1-5 cm, preferably cubes and either fried or heated in water with soup ingredients. In this embodiment the emulsion gel acts as a dairy tofu.

In another embodiment the emulsion gel is prepared from a mixture including sugar and dessert flavouring or sugar and dessert flavouring are added to the emulsified mixture before gelation. The resulting product is a dessert or jelly.

The term ‘comprising’ as used in this specification and claims means ‘consisting at least in part of’, that is to say when interpreting statements in this specification and claims which include that term, the features or steps, prefaced by that term in each statement, all need to be present but other features or steps can also be present. Related terms such as ‘comprise’ and ‘comprised’ are to be interpreted in similar manner.

### BRIEF DESCRIPTION OF THE DRAWINGS

FIG. 1 shows the changes in the storage modulus of oil/water emulsion made with 2.4% protein (WPC A392) and 10 w/w % sunflower oil during heating in the presence (♦) or absence () of 200 mM NaCl.

FIG. 2 shows the changes in the storage modulus, G′ (574 ) and loss modulus, G″ (602 ) of emulsion (2.4% whey protein (A392), 10% sunflower oil) during the heating-cooling cycle (heating at 2° C./min from 20 to 95° C. and then cooling −3° C./min from 95 to 20° C.).

FIG. 3 shows the effect of salt (NaCl) concentration on the firmness (G′) at 20° C. of heated (see FIG. 2 for details) emulsion gels made from 2.4% whey protein (WPC A392) and 10 w/w % sunflower oil.

FIG. 4 shows the effect of CaCl₂ concentration on gelling temperature (i.e. temperature at which G′ started to show noticeable increases) of emulsions consisting of 2.4% whey protein (WPC A392) and 10 w/w % sunflower oil.

FIG. 5 shows the effect of CaCl₂ concentration on the firmness (G′) at 20° C. of heated emulsions containing 2.4% protein (WPC A392) and 10 w/w % sunflower oil.

FIG. 6 shows the firmness (G′) at 20° C. of heated emulsions containing 3% protein (WPI A895) and 10 w/w % milk fat (AMF) containing 10 mM CaCl₂, 100 mM Ca₃(PO₄)₂ (TCP) or 10 mM CaCl₂ and 100 mM TCP mixture.

FIG. 7 shows the effect of protein type on emulsion gel firmness (G′) at 20° C. Emulsions were made from 10 w/w % sunflower oil and 2.4% protein, and heated using the same heating-cooling cycle as that used in FIG. 2.

FIG. 8 shows the effect of different lipid type on the firmness (G′) at 20° C. of heated (see FIG. 2 for details) emulsion gels containing 2.4% protein (WPC A392) and 10 w/w % fat/oil.

FIG. 9 shows the effect of pH on the firmness (G′) at 20° C. of heated (see FIG. 2 for details) emulsions containing 2.4% protein (WPC A392) and 10 w/w % milk fat.

FIG. 10 shows the effect of sugar concentration on the firmness (G′) at 20° C. of heated (see FIG. 2 for details) emulsions containing 2.4% protein (WPC A392) and 10 w/w % soy oil.

FIG. 11 shows the effect of homogenization pressure on the firmness (G′) at 20° C. of heated (see FIG. 2 for details) emulsions containing 2.4% protein (WPC A392) and 10 w/w % soy oil.

FIG. 12 shows the effect of heat temperature on the firmness (G′) at 20° C. of heated emulsions containing 3% protein (WPI A895) and 10 w/w % milk fat.

FIG. 13 shows the effect of heating time at 90° C. on the firmness (G′) at 20° C. of heated emulsions containing 3% protein (WPI A895) and 10 w/w % milk fat.

FIG. 14 shows the changes in the storage modulus, G′ (▪) and loss modulus, G″ (□) of emulsion during heat treatment. The emulsion gel is made with 20% emulsion powder reconstituted in water. The powder was produced from emulsion made with 3% WPC and 10% soya oil by freeze-drying.

### EXAMPLES

The following examples further illustrate practice of the invention.

### Materials and Methods

The following materials and methods were generally used in the examples listed below. The use of specific material and deviation from these general methods are specifically mentioned for each example.

### Sources of Protein

Commercial whey protein concentrates containing 80% protein were manufactured from cheese whey (ALACEN 392, A392) or acid casein whey (ALACEN 342, A342) by Fonterra Co-operative Group Limited.

Commercial whey protein isolate (ALACEN 895, A895) containing 90% protein was manufactured by Fonterra Co-operative Group Limited.

Commercial soy protein isolate (6000) containing 90% protein was manufactured by Protient.

### Sources of Fat

Fat products were sunflower oil (from supermarket), soy oil (from supermarket), and anhydrous milk fat, AMF (a commercial product)

### Salts

NaCl and CaCl₂, both were of analytical grade.

### Water

The water used in all the experiments was purified using Milli-Q system, Millipore Corp., Bedford, Mass. 01730, USA; control.

### Preparation of Oil-in-Water Emulsions

WPC solutions (pH ˜6.9) were prepared, so that upon mixing with various quantities of oil the final protein concentrations of 1-5%, w/w, were achieved, by dissolving one of the protein powders in water at 50° C. and stirring for 30 min. The protein solutions were then mixed with oil or fat so that the final mixture contained 2.5 to 20% (w/w) oil/fat.

To make stable emulsions, the mixtures were homogenized at 50° C. in a two stage homogenizer, first stage and a second-stage pressures of 400 and 50 bar respectively. The mixtures were passed through the homogenizer three times to form the fine emulsions with an average size (d₃₂) of about 0.2 μm. Salt (NaCl or CaCl₂) was then added at various levels and stages depending on the specific aims of each experiment.

### Preparation of Emulsion Gels

The homogenized emulsions were filled into glass containers or metal cans and were then heated in a water bath at 90° C. for 30 minutes or retorted at 121° C. for 16 min. The emulsions were then cooled down to the room temperature in a water bath. These heated emulsions were used for sensory evaluation or further processing such as the preparation of creamed emulsion gels.

### Dynamic Rheological Measurements

Dynamic oscillatory viscoelasticity of the emulsion gels was investigated at low strain using a controlled stress rheometer (Physica MCR301, Anton Paar, Germany) using a cup and bob configuration. About 19 ml of an emulsion sample was poured into the sample cell and covered with a thin layer of low viscosity mineral oil to prevent evaporation. The sample was then heated in situ at a rate of 2° C./min from 20 to 95° C. and cooling at a rate of 3° C./min from 95 to 20° C. The rheological properties were determined in the linear viscoelastic region (0.5% strain) and at a constant frequency of 1 Hz

### EXAMPLE 1

### Effect of Protein Concentrations on the Properties of Emulsion Gels

WPC solutions (pH ˜6.9) were prepared using A392 and then mixed various quantities of sunflower oil to make final protein concentration of 1-5%, w/w, and final oil content of 2.5 to 20%, w/w. NaCl was added at 1.2%, w/w. After homogenisation (400 bars) the emulsions were sealed in 200 ml retortable cans and then retorted (121° C. for 16 min). The firmness of the gels was evaluated by visual assessment after holding overnight. The results are shown in Table 1. The results show that even at a low protein concentrate of 1.6% and an oil concentration of 5%, the heated emulsion still formed gels. The results demonstrate that the higher the fat or the protein contents of the emulsion, the higher the gel firmness.

TABLE 1
Emulsion gel firmness.

| | Protein concentration (%, w/w) | | | | | | |
|---|---|---|---|---|---|---|---|
| Oil (%, w/w) | 1 | 1.6 | 2 | 2.4 | 3 | 3.2 | 4 |
| 5 | | 1 | 1.5 | 2 | 2.5 | 3 | 3 |
| 7 | | 2 | 2 | 2.5 | 2.5 | 3 | 4 |
| 10 | ? | 2 | 2.5 | 3 | 3 | 4 | 4 |
| 15 | ? | 3 | 3 | 4 | 4 | 4 | 4 |
| 20 | ? | 4 | 4 | 4 | 4 | 4 | 4 |

Firmness scores given to gels formed after heating or retorting of emulsions made from various concentrations of protein and sunflower oil. Scale: 0 = no gel formation, 4 = strong gel.

The strong gel (4 in the table) can be used in producing solid food such as cheese. The soft gel (<4 can be used in producing soft food such as dairy tofu and set yogurt.

This example demonstrates that emulsion gels can be formed at lower protein and fat contents than used in the prior art.

Some of the gelled emulsions were frozen to test freeze-thaw stability. The gelled emulsion structure did not collapse upon freezing and thawing: the gel firmness essentially was unchanged.

### EXAMPLE 2

### Effect of NaCl on Emulsion Gel Formation

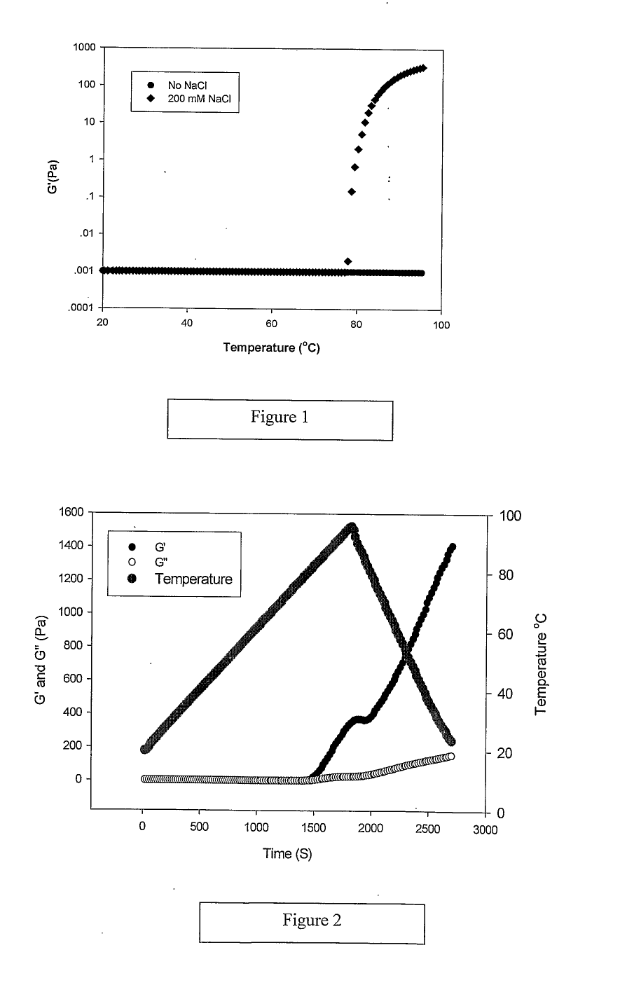

Emulsion of the same composition as that in Example 1 was heated in the presence or absence (control) of 200 mM NaCl. The results show that the storage modulus (G′) increased abruptly when the temperature reached 78° C. and beyond (FIG. 1 and FIG. 2), indicating the formation of gel at this temperature. In contrast, there were no observable changes in G′ of a control emulsion sample heated in the absence of NaCl.

### EXAMPLE 3

### Effect of Salt Concentration on the Properties of Emulsion Gels

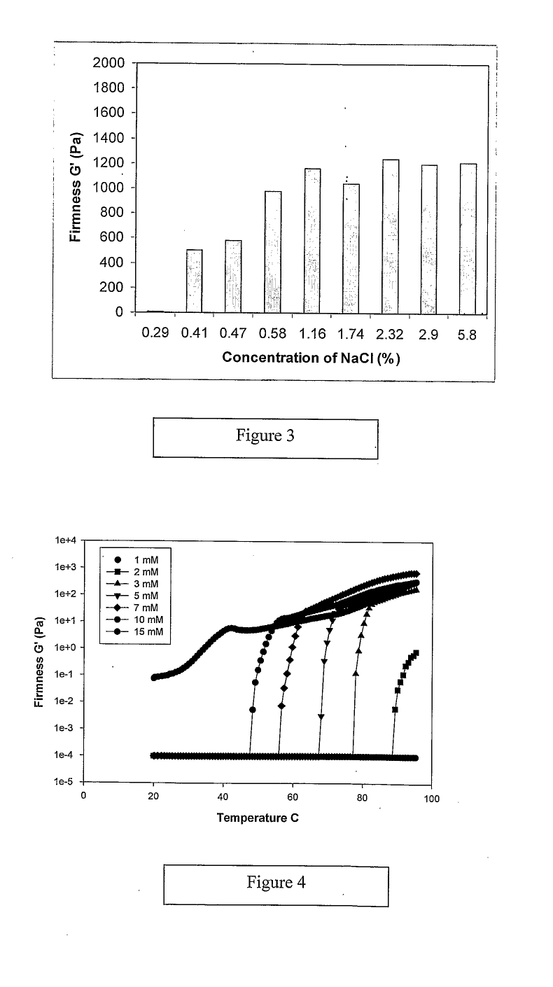

The emulsion gels consisting of 2.4% protein (A392) and 10% sunflower oil in the presence of different concentrations of NaCl were prepared under the same conditions as explained above. The firmnesses (G′), measured using the dynamic rheological measurements described in the Materials and Methods section above, of emulsion gels at 20° C. are shown in the FIG. 3. The emulsions started to form heat-induced gels at NaCl of around 0.41%. The gel firmness increased with increasing NaCl content up to 2.32% (100 mM), beyond which the gel firmness remained constant.

### EXAMPLE 4

### Effect of Calcium Concentration on the Formation and Firmness of Emulsion Gels

Emulsions containing 2.4% protein (A392) and 10%, w/w sunflower oil in the presence of different concentrations of CaCl₂, were prepared under the same conditions described in the Materials and Methods section above. FIG. 4 shows that the gelling temperature (i.e. temperature at which G′ started to show noticeable increase) decreased with the increasing CaCl₂ concentration.

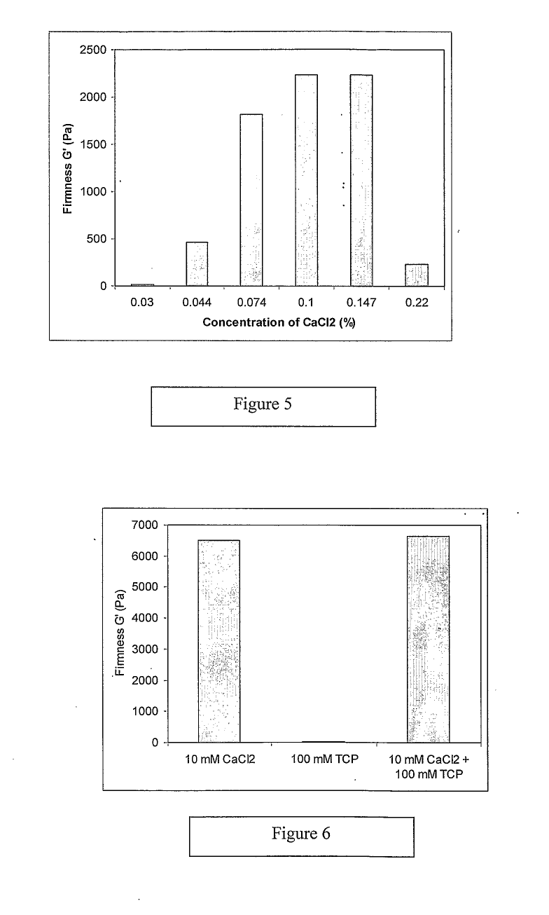

The gel firmness (G′) at 20° C. is shown in the FIG. 5. The emulsion that contained 2 mM (0.03%) CaCl₂ formed a weak gel, and the gel firmness increased with increasing concentration of CaCl₂ up to 10 mM (0.147%). However, the gel firmness was significantly reduced beyond this level.

This example demonstrates that various levels of gel firmness can be achieved from choosing different calcium levels.

### EXAMPLE 5

### Effect of Soluble Calcium ion on the Formation and Firmness of Emulsion Gels

Emulsions containing 3% protein (A895) and 10%, w/w milk fat in the presence of 10 mM CaCl₂, 100 mM Ca₃(PO₄)₂ (TCP) or 10 mM CaCl₂ and 100 mM TCP were prepared under the same conditions described in the Materials and Methods section above. TCP is not soluble at pH 7. FIG. 6 shows that the gel was formed in the emulsion containing 10 mM CaCl₂, whereas the gel was not formed in the emulsion containing 100 mM TCP. And the properties of gel formed with the emulsion in the presence of 10 mM CaCl₂ was not changed by addition of 100 mM TCP.

This example demonstrates that the free Ca²⁺ is important in the formation of whey protein emulsion gel. Insoluble calcium (such as TCP) does not affect the formation of emulsion gel at neutral pH.

### EXAMPLE 6

Effect of Protein Type on the Properties of Emulsion Gel

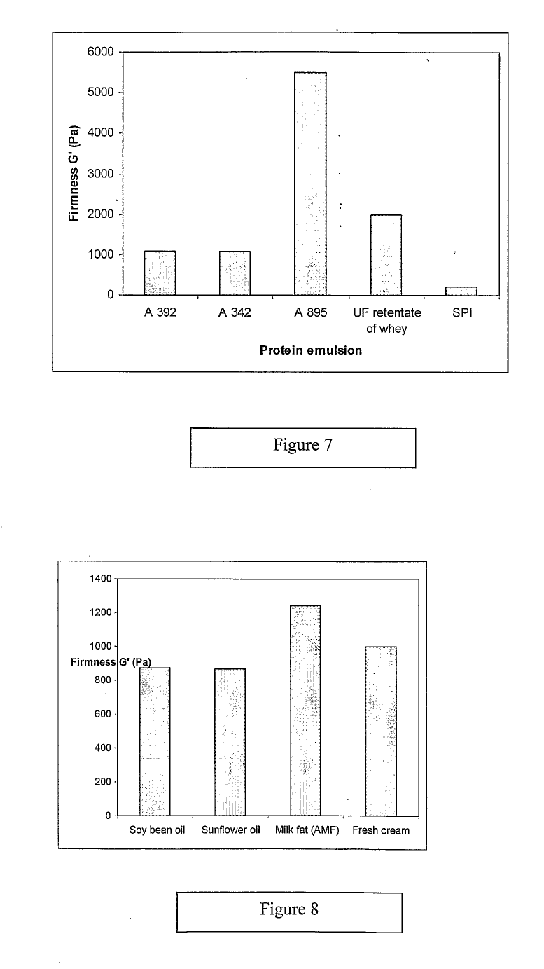

Emulsions consisting of 2.4% protein using A392, A342, A895, or SPI and 10% sunflower oil and 200 mM NaCl were prepared using the same conditions as in Example 2. The firmness (G′), measured using the dynamic rheological measurements described in the Materials and Methods section above, of emulsion gels at 20° C. is shown in the FIG. 7. The results show that the emulsion gel made with WPCs (A392 and A342) had similar gel firmness. The emulsion gel made with WPI had much higher firmness (˜five times), and emulsion gel made with UF whey retentate had higher firmness than that of emulsion gel made with WPCs (˜two times), but SPI emulsion gel had a much lower firmness (many times lower than either WPC or WPI).

This example demonstrates that various levels of gel firmness can be achieved from choosing different protein source.

### EXAMPLE 7

### Effect of Lipid Type on the Properties of Emulsion Gels

The gels made from emulsions containing 2.4%, w/w protein (A392) and 10%, w/w sunflower oil, soy bean oil or milk fat, and 200 mM NaCl, were prepared using the same conditions described above. The firmness (G′) of emulsion gels at 20° C., measured using the dynamic rheological measurements described in the Materials and Methods section above, is shown in the FIG. 8. The emulsion gels formed with soy bean oil and sunflower oil had similar firmness, while the emulsion gel made with fresh cream had higher firmness and milk fat (AMF) emulsion gel had highest firmness.

It is clear that different types of fat provide different firmness to the emulsion gels. Those who are skilled in the art would be familiar with the fact that there is a wide range of lipids that can be used in these emulsions. The effects of different lipids are dictated by their variation in molecular structure, e.g. degree of saturation.

### EXAMPLE 8

### Effect of pH on the Properties of Emulsion Gel

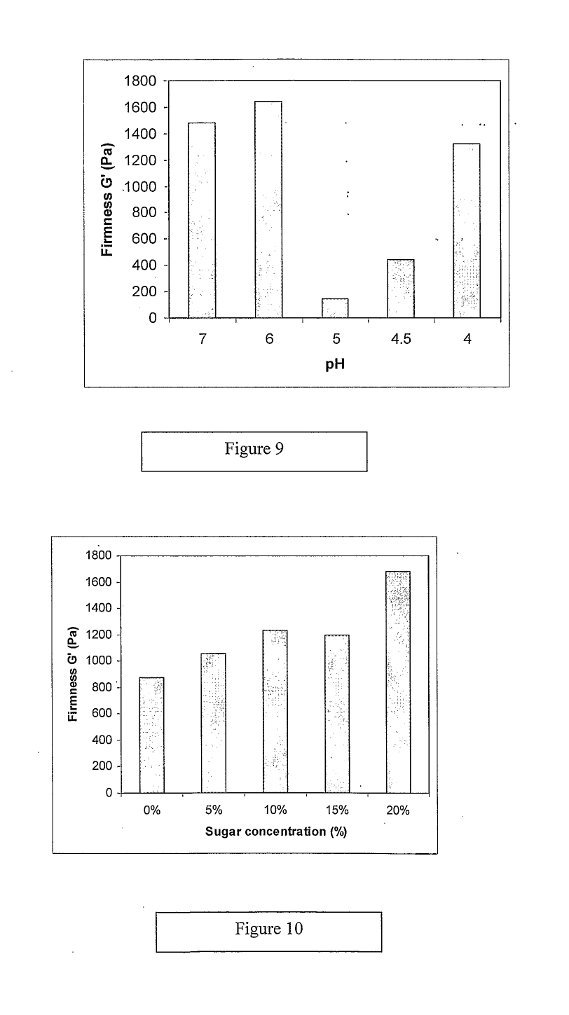

Emulsions containing 2.4% protein (A392) and 10% milk fat were prepared under the same conditions as described above. The pH of each emulsion was adjusted to pH 7.0, pH 6.0, pH 5.0, pH 4.0; pH 3.5 or pH 3.0 then heated using the heating-cooling cycle described in FIG. 2. Emulsions at pH lower than 3.5 did not form gels after heating to 95° C. (results not shown). The gel firmness (G′) at 20° C. is shown in the FIG. 9. The gel firmness at pH 5 and pH 4.5 were lower than that of gel obtained from the emulsions at pH 7, pH 6 or pH 4.

This example demonstrates that various levels of gel firmness can be achieved at different pHs. Manipulation of pH can be helpful in achieving a desired texture in a product. The technology also offers applications at low pH products such as yoghurt.

### EXAMPLE 9

### Effect of Sugar Concentration on the Properties of Emulsion Gels

Emulsions containing 2.4% protein (A392), 10%, w/w, soy oil and different concentrations of sugar were prepared under the same conditions as in the Materials and Methods section. The firmness (G′) of emulsion gels at 20° C. is shown in the FIG. 10. The firmness of gel increased with increasing sugar content. This was probably due to increasing total solids in these emulsions.

This example demonstrates that the emulsion gels are stable in the presence of sugar, indicating that the emulsion gel structure holds in the presence of other ingredients. This characteristic is useful as most composite foods contain other ingredients such as sugar and flavours.

### EXAMPLE 10

### Effect of Homogenization Pressure on the Properties of Heat-Induced Emulsion Gels

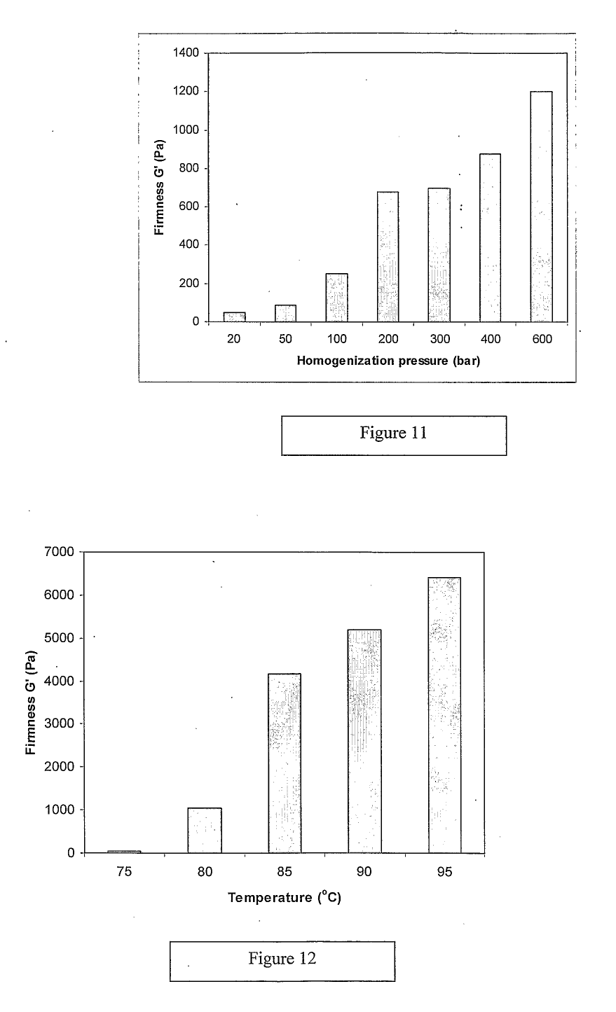

Emulsions containing 2.4% protein (A392) and 10% soy oil were prepared under different homogenization 1^{st} stage pressures while holding the 2^{nd} stage pressure at 50 bar. The emulsion gel were prepared under the same conditions as in the Materials and Methods section. The firmness (G′) of emulsion gels at 20° C. is shown in the FIG. 11. The firmness (G′) of gel increased with increasing homogenization pressure. The gel is very weak at pressure lower than 200 bar.

It is clear that manipulation of the processing conditions, such as the homogenisation pressures, can be used to achieve levels of firmness in emulsion gels.

### EXAMPLE 11

### Effect of Temperature and Time of Heat Treatment on the Properties of Heat-Induced Emulsion Gels

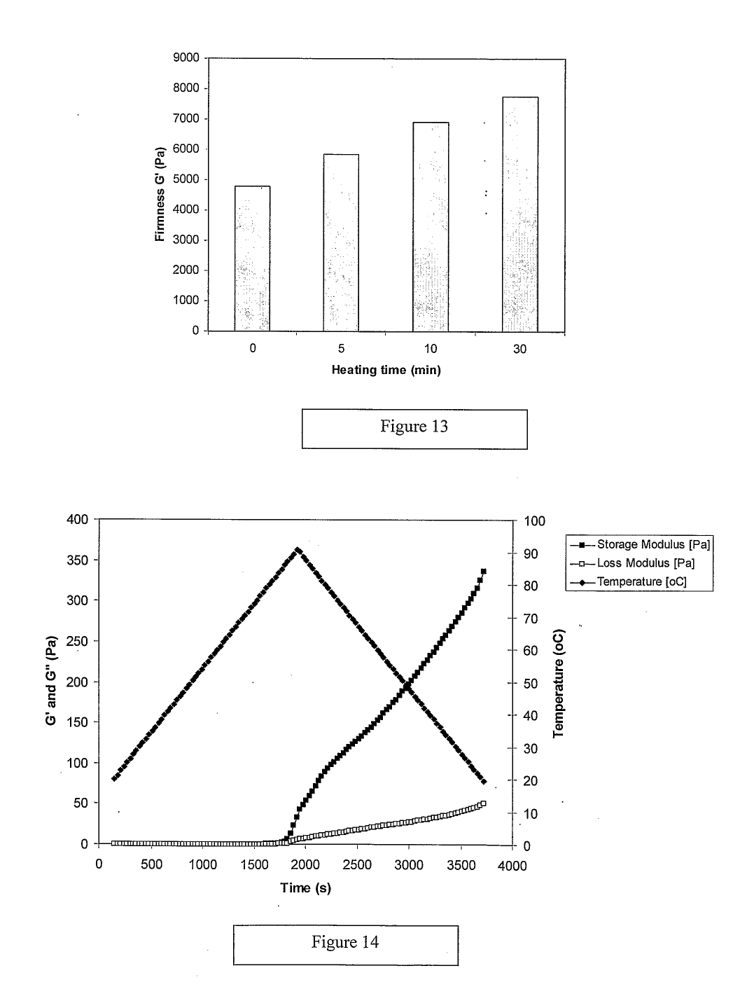

Emulsions containing 3% protein (A895) and 10% milk fat (AMF) were prepared under homogenization 1^{st} stage pressures at 400 bar and the 2^{nd} stage pressure at 50 bar. The emulsions containing 150 mM NaCl were heated at different temperatures from 75 to 95° C. and different heat time at 90° C. and cooled down to 20° C. The firmness (G′) of emulsion gels at 20° C. is shown in the FIG. 12. The firmness (G′) of gel increased with increasing heat temperature. The gel is very weak at heat temperature lower than 75° C. FIG. 13 shows that the firmness (G′) increased when the holding time was increased at same heating temperature.

This example demonstrates that manipulation of the processing conditions, such as the heat temperature and heating time, can be used to achieve levels of firmness in emulsion gels.

### EXAMPLE 12

### Gelation of Emulsion Reconstituted from Emulsion Powder Made with Whey Protein Emulsions

Emulsion containing 3% whey protein (WPC A392) and 10 w/w milk fat (AMF) was adjusted to pH 3.0 and was dried to powder by freeze-drying.

Above emulsion powder was reconstituted with water to emulsion with ˜4% protein and ˜15% fat. The reconstituted emulsion was adjusted to pH 6.7. The emulsions containing 150 mM NaCl were heated to 90° C. and cooled down to 20° C. The storage modulus, G′ (▪) and loss modulus, G″ (□) of emulsion during heat treatment is shown in FIG. 14.

FIG. 14 shows that the reconstituted emulsions formed the gel (\acute{G}′>G″) at ˜80° C. and the firmness increased with an increase in the temperature and during cooling. This indicates the gelation properties of emulsion reconstituted from the emulsion powder are similar to that of emulsions made with WPC and oil (FIG. 2).

This example demonstrated that emulsions made with whey proteins can be dried to powder. The emulsion reconstituted from the emulsion powder also can be used to form the gel under same conditions as the gelation of emulsion without dried. The properties of gel made from emulsion reconstituted powder are similar to that of gel made from heated emulsions. It can be used to produce an ingredient, which can be used to achieve a desired formulation in making emulsion gel or food product after reconstitution.

### EXAMPLE 13

### Emulsion Gel was Cooked to Sauteing Dairy Tofu and Dairy Tofu Soup

Emulsion gel (Dairy tofu) consisting of 2.4% protein using A392 and 10% sunflower oil and 150 mM NaCl were prepared using the same conditions as in Example 1.

### Sauteing Dairy Tofu (Emulsion Gel)

Cut Dairy Tofu (emulsion gel) into cubes and add it to hot oil in a skillet. Sautee it for a few minutes until it turns golden. You can either add it to a stir-fry or eat it plain or with a dipping sauce.

### Stir-Fry Ingredients:

1 each medium sized red and green pepper (julienne cut)

1 medium onion (julienne cut)

1 carrot (julienne cut)

2 stalks celery (bias cut)

1 cup fresh brocolli florettes

1 cup fresh bean sprouts

Oil (for cooking)

### Directions:

Cut dairy tofu into ½ inch by 1 inch pieces.

Mix all marinade ingredients together and toss dairy tofu in marinade. Let stand for at least 30 minutes tossing occasionally.

While dairy tofu is marinating, cut all ingredients for the stir-fry. In a wok or deep sided fry pan, heat to medium-hot, 1-2 TBS of good quality oil (canola or olive oil work well).

Remove dairy tofu from marinade and stir-fry for 2 minutes (save marinade for sauce). Remove dairy tofu and set aside.

Stir-fry peppers, onion, carrot and celery for 3-4 minutes. Add brocolli and sprouts and fry another 2 minutes. Add marinade and bring liquid to a boil.

Result shows that dairy tofu is remained in the cube shape and the texture and taste are accepted.

### Dairy Tofu Soup

Add 600 ml water into a saucepan.

Add a bag McCormick (McCormick foods Co., Ltd, Shanghai, China) hot and sour soup seasoning and stir until evenly dispersed.

Add 200 g dairy Tofu cubes, bring water to a boil.

Stir in one beaten egg and remove from heat serve.

Garnish with chopped green onions or coriander leaves.

Optional: for variation add diced meat like chicken, pork, fish, shrimp or crab to soup stock.

Result shows that dairy tofu is remained in the cube shape and the texture and taste are accepted.

This example indicates that the emulsion gel can be applied as a dairy tofu cooking as a tradition soybean tofu. The texture of dairy tofu can be served on the table as cooked dishes as service of soy tofu.

### EXAMPLE 14

### Instant Sweet Dairy Dessert or Flavour Silk Tofu Made with Whey Protein Emulsion Gel

Formula: 3% WPC (A392), 7 w/w % milk fat (AMF), 10% sugar, 0.8% NaCl and 0.1% green tea flavour.

Process: WPC solutions with sugar (pH ˜6.9) were prepared at 50° C. for 30 min and then mixed with milk fat. The protein and milk fat mixture was homogenized at 400/50 bar and at 50° C. After homogenisation, NaCl and flavour were added to the emulsions and then emulsions were sealed in 200 ml retortable cans and then retorted (121° C. for 16 min).

After cooling, the gel in the cans can be served as an agreeable taste dairy dessert or flavour silk tofu with a pleasant mouthfeeling.

### Utility

Those skilled in the art would appreciate that:
Those gels could be prepared from a wide range of:
   Protein/water/oil compositions
   Temperature/time combinations to get gels
The emulsions can include oil-soluble materials
One can add flavours, colours, and many other ingredients that can improve the qualities of those emulsion gels.

In general, the invention following benefits and applications:
Tofu kind products made from milk proteins.
Packaged dairy Tofu with sterilization.
Dairy dessert or Jellies.
Dairy cakes.
Whey protein cheese

### General

Any discussion of documents, acts, materials, devices or the like that has been included in the present specification is solely for the purpose of providing a context for the present invention. It is not to be taken as an admission that any or all of these matters forms part of the prior art base or were common general knowledge in the field relevant to the present invention as it existed before the priority date.

The above examples are illustrations of the practice of the invention. It will be appreciated by those skilled in the art that the invention can be carried out with numerous modifications and variations. For example, the emulsion can show variations in protein concentration and pH, the methods of emulsification can be varied, and the oils or fats and whey protein sources and heating steps can also be varied.

1. A method for preparing a gel comprising:
(a) mixing oil or fat with an aqueous medium by homogenisation to form an oil-in-water emulsion; and
(b) heating the mixture to 50° C. to 200° C. for a period sufficient to form an emulsion gel
wherein the mixture comprises 1.0% to 3.8% (w/w) of a protein that forms a heat-set gel, and 5 to 18% oil or fat or a mixture of oil and fat.

2. A method as claimed in claim 1 wherein the protein is selected from the group consisting of soy proteins, whey proteins, myofibrillar (skeletal/meat) proteins, egg proteins, and blood proteins.

3. A method as claimed in claim 2 wherein the protein is selected from the group consisting of soy proteins and whey proteins.

4. A method as claimed in claim 3 wherein the protein is whey protein.

5. A method as claimed in claim 4 wherein the whey protein content of the emulsion is 1.4 to 3.7% (w/w).

6. A method as claimed in claim 5 wherein the whey protein content is 1.8% to 3.5%.

7. A method as claimed in claim 4 wherein the whey proteins are provided from a whey protein isolate (WPI) or a whey protein concentrate (WPC).

8. A method as claimed in claim 1 wherein the mixture comprises 7% to 15% oil or fat.

9. A method as claimed in claim 1 wherein the oil or fat is vegetable oil or milk fat.

10. A method as claimed in claim 1 wherein the emulsion is heated to a temperature of 80° C. to 150° C.

11. A method as claimed in claim 1 wherein exogenous soluble calcium ions or sodium ions are added.

12. A method as claimed in claim 1 wherein sodium chloride is added to raise the sodium chloride concentration by 10 to 300 mM.

13. A method as claimed in claim 1 wherein calcium chloride is added to the mixture to increase the concentration by 4 to 12 mM.

14. A method as claimed in claim 1 wherein the pH of the aqueous medium is in the range 4.0 to 7.5.

15. A method as claimed in claim 14 wherein the pH is in the range 5.5 to 7.5.

16. A method as claimed in claim 14 wherein the pH is in the range 4.0 to 4.5.

17. A method as claimed in claim 1 wherein sugar is included in the gel.

18. A method as claimed in claim 1 where the homogenisation pressure is 300 to 2000 bar.
